(19) United States
(12) Patent Application Publication
(10) Pub. No.: US 2009/0200183 A1
(43) Pub. Date: Aug. 13, 2009

(54) Personalizeable presentation apparatus for jewelry or other article

(76) Inventor: John H. Dussin, Portland, OR (US)

Correspondence Address: STEVEN J. ADAMSON, PC, P.O. BOX 5997, PORTLAND, OR, 97228, US

(21) Appl. No.: 12/313,540

(22) Filed: Nov. 20, 2008

Related U.S. Application Data
(60) Provisional application No. 61/065,133, filed on Feb. 9, 2008.

(51) Int. Cl. A45C 11/16; F21V 33/00

(52) U.S. Cl. 206/6.1; 362/155

(57) ABSTRACT

A jewelry or other item presentation device that has a housing having a top section and a bottom section and a platform therein configured to hold jewelry or another item for presentation. A light source, sound source, platform drive motor and control logic are preferably provided within the housing. Through the control logic, a user may program aspects of the light, sound and/or platform movement to personalize the experience that occurs upon opening the device.

### CROSS-REFERENCE TO RELATED APPLICATIONS

This application claims the benefit of Provisional Application No. 61/065,133, filed Feb. 9, 2008, entitled “Presentation Apparatus for Jewelry or Other Articles” and having same inventor(s) as above and Provisional Application No. 61/072,629, filed Mar. 31, 2008, and having the same title and inventor(s) as above.

### FIELD OF THE INVENTION

The present invention relates to cases or boxes for the display or presentation of an article. More specifically, the present invention relates to boxes for the presentation of jewelry, particularly jewelry with sentimental value such as an engagement ring.

### BACKGROUND OF THE INVENTION

The prior art contains various boxes and other containers for display, presentation and storage of jewelry and other articles. Patents that cover these devices include the following.

U.S. Pat. No. 712,112 was issued to Arnold, on Oct. 28, 1902, for an Illuminated Watch Box. This patent discloses a storage box for a pocket watch that contains a battery and an electric lamp.

U.S. Pat. No. 5,329,422 was issued to Geeting et al., on Jul. 12, 1994, for a Lighted Jewelry Box. This patent discloses a high-intensity electric lamp mounted, along with a reflector, in the top section of the hinge jewelry box.

U.S. Pat. No. 6,405,858 was issued to Gagliardi on Jun. 18, 2002, for a Jewelry Enhancing Lighting Device and Process. This patent teaches a hinge jewelry box having a speaker capable of playing music. This patent also mentions a sound recordable chip on to which a message may be prerecorded.

U.S. Pat. No. 7,251,957 was issued to Solomon on Aug. 7, 2007, for a Musical Jewelry Apparatus. This patent illustrates a locket having a musical circuit that preferably plays a single prerecorded tune when the locket is opened.

These and related devices are disadvantageous because, among other reasons, they do not provide the user with the opportunity to create or “personalize” the mood created when the presentation box is opened. They may, for example, have a prerecorded song or message, but they are limited to that particular song or message (in its content, volume level and/or when it plays). Prior art devices are also limited in that they are either lit or not lit and a user is not provided with the opportunity to select lighting characteristics, such as intensity, color, on/off, etc. Furthermore, prior art devices are limited in that they do not provide movement of the article to be displayed, such as a rotating turntable on which a ring is mounted. There is also no provision in the prior art for user-based control of the movement.

A need exists for user-programmable control of audio signals, light quality and article movement and various combinations of these features to permit a user to “personalize” the effect experienced by someone opening the display box.

### BRIEF DESCRIPTION OF THE DRAWINGS

FIG. 1 is a perspective exploded view of a jewelry presentation device in accordance with the present invention.

FIG. 2 is a perspective view of the device of FIG. 1 in an open position.

FIG. 3 is a representative graphic user interface for selecting light, sound and movement control parameters for the device of FIG. 1.

FIG. 4 is a representative graphic user interface for selection of an audio file.

### DETAILED DESCRIPTION

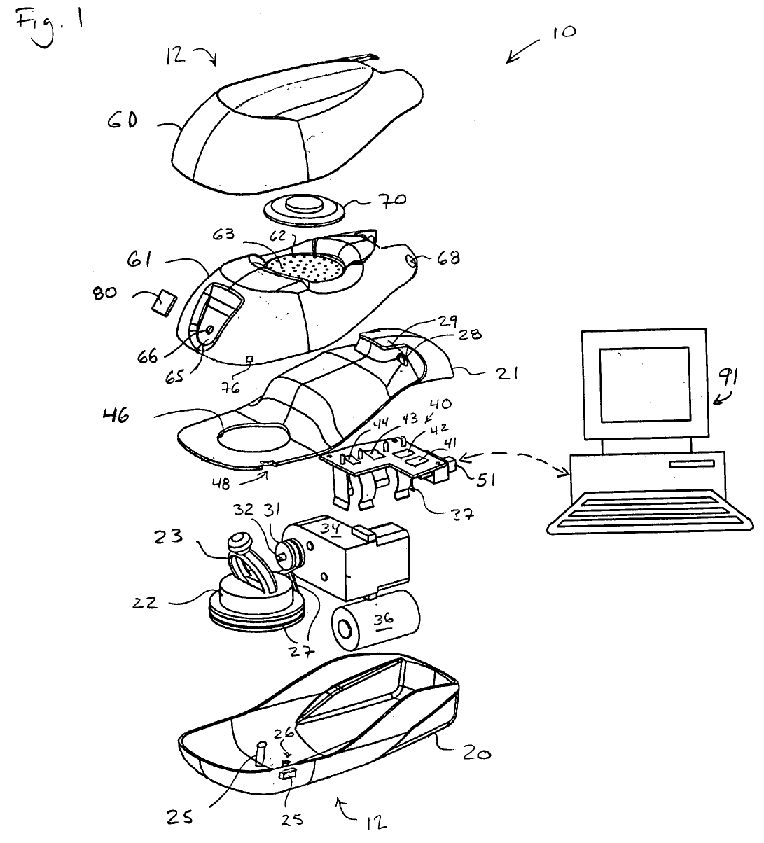

Referring to FIG. 1, a perspective exploded view of a jewelry presentation device 10 in accordance with the present invention is shown. Device 10 may have a housing 12 that includes a bottom section 20, a bottom section cover member 21, a top section 60 and a top lining member 61.

Bottom section 20 may house a platform 22 or the like that is suitably constructed to receive a ring 23 or other item to be presented. The platform may mount to a shaft 25 extending upwardly from the bottom section or be seated in the cover member 21 and/or the like. A drive belt 27 may couple platform member 22 to a sheave or drum 31 that is mounted to shaft 32 of motor 34. Motor 34 is preferably an electric motor that is powered by battery 36, which may be held by a clip 37. In the embodiment of FIG. 1, the clip 37 is mounted to a printed circuit board 40. Suitable batteries are known in the art and include lithium-manganese dioxide batteries.

The printed circuit board (PCB) 40 may include a controller 41, memory 42, a sound chip 43 and related components 44, and communication conduits including signal lines to programming port 51, sound source 70, light source 80, and motor 34, among others. Communication conduits (i.e., wires) are not shown for clarity of drawing but are known. Battery 36 is preferably nested adjacent motor 34 with PCB 40 provided immediately above. These components may be arranged together substantially as shown in bottom section 20 or in another compact arrangement. The cover member 21 is provided over these components and securely fastened to bottom section 20 so as to hold and protect these components. Platform 22 is preferably positioned through opening 44 in cover member 21.

Top section 60 is preferably configured, together with lining 61, to house the sound and light sources 70,80. Lining 61 may have a recess 62 with a perforated face member 63 on to which the sound source or speaker 70 is placed. Speaker 70 may be any suitable speaker device of which many are known in the art (including, for example, those found in laptop computers, MP3 players and other portable electronic devices).

Lining 61 may have a recess 65 or other feature to receive a light source 80, which is preferably an LED unit. An opening or aperture 66 is created in recess 65 through which light from LED unit 80 is directed onto an article mounted in platform 22 (when device 10 is in the open position).

As discussed in more detail below, the LED unit 80 may include RGB diodes to create an output light of nearly any color within the visible light spectrum. The LED unit 80 can also be programmed to emit a light that varies in color over time. Furthermore, the diodes may be programmed to turn on and off in a particular pattern to give a twinkle or dance-floor swirl or other illumination pattern.

Top section 60 and bottom section 20 are preferably coupled to each other by a hinge or pivot arrangement so that the top section may be opened/lifted relative to the bottom section. A spring is preferably provided at the hinge to bias the top in an open position. The top section is preferably held closed by a clasp discussed below. In FIG. 1, lining 61 has a pair of openings 68 that mate with protrusions 28 in cover member 21. The protrusions and openings are preferably shaped such that the top section stays open when lifted in the absence of a closing force.

Device 10 may be programmed via port 51 by a computer or other electronic processing device 91. While a desktop computer is shown in FIG. 1, it should be recognized that a portable or handheld processing device maybe used and that communication between port 51 and an external device may be wired or wireless.

FIG. 1 also illustrates a release button 25. For simplicity and ease of opening, and to increase the dramatic effect, a single one-button release is preferably provided with the device. Button 25 preferably protrudes through bottom housing section 20 and is coupled to latch 26. Latch 26 extends through recess 48 and above lining 21 and is received in opening 76 in top lining 61. Latch 26 is biased outwardly and couples into opening 76 when the top section is closed onto the bottom section. Depression of button 25 moves the latch out of opening 76 and bias member 29 pushes open the top housing.

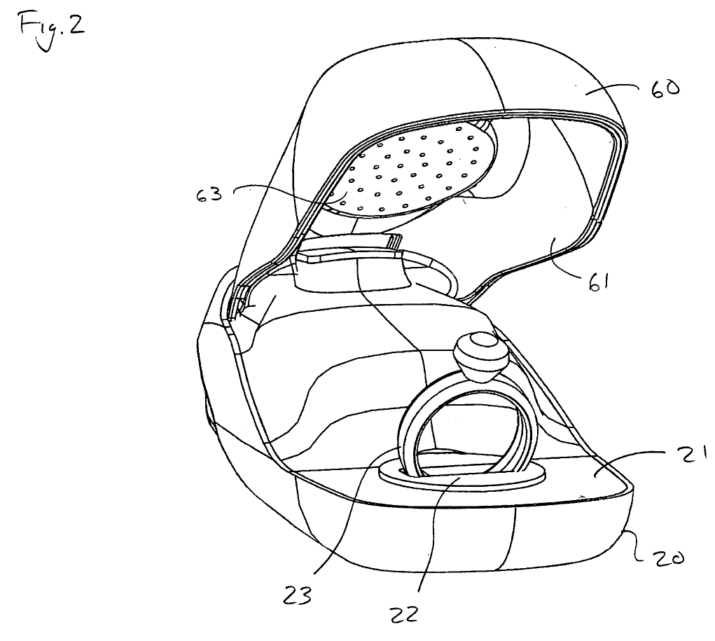

Referring to FIG. 2, a perspective view of device 10 in the open position is shown. FIG. 2 illustrates several features including the mounting of cover member 21 onto bottom housing 20 and the position of platform 22 therein. Speaker face member 63 and portions of lining member 61 are also shown, while LED unit 80 is covered by top section 60.

A sensor is provided to detect when the housing is opened. Sensors for this purpose are known in the art. When the housing is opened, controller 41 turns on the LED unit, begins emission of the audio file, and moves platform 22 also as programmed by a user.

Materials for fabrication of the components described herein are known in the art.

### Operation

The present invention is preferably configured to permit an end user to create and hence “personalize” the ambiance or environment experienced by one viewing the ring or other item when device 10 is opened. This includes, but is not limited to, permitting user selection of light, sound and/or platform movement characteristics. This selection or programming is preferably achieved by use of a computer coupled through a wired or wireless connection to port 51. An audio file and control parameters are downloaded to controller 41 and memory 42. Logic operating on controller 41 retrieves and transmits the audio file to speaker 70 when appropriate and implements the other programmed control parameters.

Referring to FIG. 3, a representative graphic user interface 110 for selecting light, sound and movement control parameters in accordance with the present invention is shown. Via software and appropriate drivers loaded onto a computer or other suitable electronic device, Blackberry, PDA, etc. (91 of FIG. 1), a user may select the control parameters and transfer those parameters via part 51 to the controller.

Using a cursor, the user may select a light intensity level and light color. Various light patterns may also be selected including spot light, wash (an undulating or non-undulating generally softer intensity), dance floor swirl-white, dance floor swirl-color, etc. If no light is desired, a user may simply select zero on the intensity indicator 111. Color may be achieved by using an array of different color LEDs that are selectively activated to form a desired output color. A user selects a color from the visible color spectrum indicator 112. Color Kinetics is a source of RGB. LED lights. Using pattern indicator 113 a user may select among spotlight (SL), wash (WA), dance floor swirl-white (DFW) and dance floor swirl-color (DFC). The floor swirl pattern is similar to that achieved with a dance floor revolving mirrored ball and can be achieved by selected illumination of LEDs in and LED array in unit 80.

The sound level is preferably selected by a user moving a cursor or other pointing device to a desired location along a volume indicator 114. A user may also select the amount of delay between opening and the emission of the audio file and whether the audio file repeats.

In addition, the rate of speed at which the platform rotates may also be selected by sliding the selection bar along the speed indicator 116 or other suitable means. By clicking on APPLY or OK the setting are downloaded to device 10 in a conventional manner and stored in memory 42 for execution by controller 41 when the device is opened. A user may open device 10 to test the selected settings and re-adjust as desired.

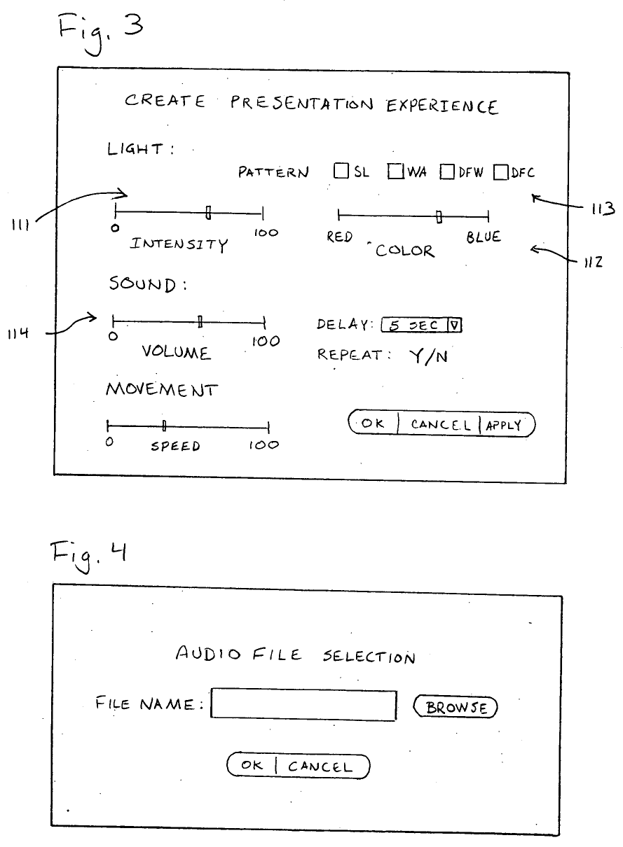

FIG. 4 represents selection of the audio file. Any suitable audio file, however generated, may be selected and downloaded to device 10 for emission at the volume, delay and any other parameters selected by the user. The audio file may be edited, cropped or otherwise processed by audio signal processing software before download to device 10. Various audio signal processing software is known in the art.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A jewelry or other item presentation device, comprising:
a housing that includes a bottom section and a top section that are configured for movement between an open position and a closed position;
a platform member located in the bottom section that is adapted to receive an item to be presented by the device;
a light source that illuminates the platform when the housing is in the open position;
a sound source that emits a programmed sound when the housing is in the open position;
an electronic controller with memory that is coupled to the light source and sound source;
a port for external electronic communication between an external end user and the controller; and
logic operating within the controller that permits an end user to personalize the audio signal emitted by the sound source by programming into memory one or more of the sound volume emitted by the sound source and the given audio signal emitted through the sound source when the housing is in the open position;
wherein the logic and controller are further configured to permit a user to program light source characteristics including one or more of light of intensity, light color and light pattern.

2. The device of claim 1, wherein the controller and logic are configured to permit a user to program two or more of the intensity, color and illumination pattern of the light source.

3. The device of claim 1, wherein the platform member is movable.

4. The device of claim 3, further comprising a motor that moves the platform member and wherein the controller and logic are configured to permit a user to program at least one of the rate of movement and the pattern of movement of the platform member.

5. The device of claim 1, wherein the controller and logic are configured to permit a user to program the sound volume emitted by the sound source and the given audio signal emitted through the sound source.

6. The device of claim 4, wherein the controller and logic are configured to permit a user to program the sound volume and the given audio signal emitted by the sound source when the housing is in the open position.

7. The device of claim 6, wherein the controller and logic are configured to permit a user to program two or more of the intensity, color and illumination pattern of the light emitted from the light source.

8. A jewelry or other item presentation device, comprising:
a housing that includes a bottom section and a top section that are configured for movement between an open position and a closed position;
a platform member located in the bottom section that is adapted to receive an item to be presented by the device;
a light source that illuminates the platform when the housing is in the open position;
a sound source that emits a programmed sound when the housing is in the open position;
an electronic controller with memory that is coupled to the light source and sound source;
a port for external electronic communication between an external end user and the controller; and
logic operating within the controller that permits an end user to personalize characteristics of the light emitted by the light source by programming into memory at least one of the intensity, color and illumination pattern of the light emitted by the light source when the housing is in the open position.

9. The device of claim 8, wherein the controller and logic are configured to permit a user to program two or more of the intensity, color and illumination pattern of the light emitted by the light source.

10. The device of claim 8, wherein the platform member is movable and the controller and logic are configured to permit a user to program at least one of the rate of movement and the pattern of movement of the platform member.

11. The device of claim 8, wherein the controller and logic are configured to permit a user to program one or more of the sound volume emitted by the sound source and the given audio signal emitted through the sound source when the housing is in the open position.

12. The device of claim 9, wherein the controller and logic are configured to permit a user to program one or more of the sound volume emitted by the sound source and the given audio signal emitted through the sound source when the housing is in the open position.

13. A jewelry or other item presentation device, comprising:
a housing that includes a bottom section and a top section that are configured for movement between an open position and a closed position;
a motor provided within the housing;
a platform member located in the bottom section that is adapted to receive an item to be presented by the device and configured for movement as driven by the motor;
a light source that illuminates the platform when the housing is in the open position;
a sound source that emits a programmed sound when the housing is in the open position;
an electronic controller with memory that is coupled to the light source and sound source;
a port for external electronic communication between an end user and the controller; and
logic operating within the controller that permits an end user to program the rate of movement of the platform member.

14. The device of claim 13, wherein the logic and controller are configured to permit an end user to personalize characteristics of the light emitted by the light source by programming into memory at least one of the intensity, color and illumination pattern of the light emitted by the light source when the housing is in the open position.

15. The device of claim 13, wherein the logic and controller are configured to permit an end user to personalize characteristics of the light emitted by the light source by programming into memory two or more of the intensity, color and illumination pattern of the light emitted by the light source when the housing is in the open position.

16. The device of claim 15, wherein the logic and controller are configured to permit a user to program the sound volume emitted by the sound source and the given audio signal emitted through the sound source when the housing is in the open position

17. A method of presenting jewelry or other item, comprising the steps of:
providing a housing that includes a bottom section and a top section that are configured for movement between an open position and a closed position,
providing a platform member located in the bottom section that is adapted to receive an item to be presented;
providing a programmable controller and logic operating thereon;
providing a port for external electronic communication between an external end user and the controller;
programming one or more of light intensity, color and illumination pattern of a light source coupled to the housing that illuminates the platform when the housing is in the open position; and
programming one or more of volume and the audio signal emitted by a sound source coupled to the housing that emits a programmed sound when the housing is in the open position.

18. The method of claim 17, further comprising the steps of providing a drive mechanism for driving movement of the platform and programming the rate of movement of the platform.

19. The device of claim 1, further comprising a bias mechanism that biases the top section to an open position and a releasable latch member that holds the top section in a closed position.

20. The device of claim 13, further comprising a bias mechanism that biases the top section to an open position and a releasable latch member that holds the top section in a closed position.
